(19) United States
(12) Patent Application Publication
(10) Pub. No.: US 2025/0347136 A1
(43) Pub. Date: Nov. 13, 2025

(54) SWIMMING-POOL WATER SURFACE MAP CREATING METHOD AND SWIMMING POOL CLEANING DEVICE

(71) Applicant: Shenzhen Aiper Intelligent Co. Ltd., Shenzhen (CN)

(72) Inventors: Xuhang CAI, Shenzhen (CN); Lingjie PENG, Shenzhen (CN); Zhenzhen LIANG, Shenzhen (CN)

(73) Assignee: Shenzhen Aiper Intelligent Co. Ltd., Shenzhen (CN)

(21) Appl. No.: 18/931,094

(22) Filed: Oct. 30, 2024

(30) Foreign Application Priority Data
May 9, 2024 (CN) 202410571739.1
Aug. 2, 2024 (CN) 202411059725.8

(51) Int. Cl. E04H 4/16; G06T 7/62

(52) U.S. Cl. CPC E04H 4/1654; G06T 7/62

(57) ABSTRACT

A swimming-pool water surface map creating method is provided. In the method, an instruction of creating a water surface map is generated; based on the instruction, position information of a swimming pool robot floating on a water surface is acquired; swimming pool boundary information collected by the swimming pool robot is acquired through a laser radar or an image sensor; and the water surface map of a swimming pool is generated based on the position information and the swimming pool boundary information, thus providing convenience for water surface working of a swimming pool cleaning device, improving a working efficiency of the swimming pool cleaning device, and improving user experience.

### CROSS REFERENCE TO THE RELATED APPLICATIONS

This application is based upon and claims priority to Chinese Patent Application No. 202410571739.1, filed on May 9, 2024, and Chinese Patent Application No. 202411059725.8, filed on Aug. 2, 2024, the entire contents of which are incorporated herein by reference.

### TECHNICAL FIELD

The present application relates to the field of robot technologies, and in particular, to a swimming-pool water surface map creating method and a swimming pool cleaning device.

### BACKGROUND

Currently, most swimming pool robots cannot clean a water surface, and for a small number of swimming pool robots capable of cleaning the water surface, a random walking mode is generally adopted to clean the water surface, and positioning and map concepts are not involved. Such an implementation is not intelligent enough, and has a low cleaning efficiency, low coverage and poor user experience.

Or, measurements of sensors adopted during mapping are inaccurate and prone to be influenced by the environment, such that mapping fails or a mapping error is large, and thus, a map cannot be directly used.

### SUMMARY

In view of this, embodiments of the present application provide a swimming-pool water surface map creating method and apparatus, so as to solve the problem in the prior art that no water surface map of a swimming pool is created or a created map is inaccurate.

In a first aspect of the embodiments of the present application, there is provided a swimming-pool water surface map creating method, including:
generating an instruction of creating a water surface map;
based on the instruction, acquiring position information of a swimming pool robot floating on a water surface;
acquiring swimming pool boundary information collected by the swimming pool robot through a laser radar or an image sensor; and
generating the water surface map of a swimming pool based on the position information and the swimming pool boundary information.

Further, the swimming-pool water surface map creating method includes: judging whether a swimming pool boundary of the water surface map is closed, and if the swimming pool boundary is not closed, controlling the swimming pool robot to collect a non-closed region of the boundary, so as to generate a final water surface map.

Further, the position information or the swimming pool boundary information is calibrated by an IMU on the swimming pool robot.

Further, the controlling the swimming pool robot to collect a non-closed region of the boundary includes controlling the swimming pool robot to move towards the non-closed region.

Further, at least two non-closed regions are included; the controlling the swimming pool robot to move towards the non-closed region includes: determining a target boundary non-closed region closest to the swimming pool robot; and controlling the swimming pool robot to move to the target boundary non-closed region.

Further, the boundary information includes information of obstacles on the water surface.

Further, the method includes: after the water surface map of the swimming pool is generated, in response to receiving a robot summoning instruction including target position information, controlling the swimming pool robot to move to a target position based on the target position information and the water surface map.

Further, the method includes: after the water surface map of the swimming pool is generated, in response to receiving a swimming pool cleaning instruction, controlling the swimming pool robot to clean the swimming pool and recording a cleaned region in the water surface map; in response to receiving a cleaning pause instruction, recording a target position and a target posture of the swimming pool robot at a current moment in the water surface map; in response to receiving a cleaning continuing instruction, controlling the swimming pool robot to move to the target position and adjusting the swimming pool robot to the target posture; and planning a cleaning path in the water surface map, and controlling the swimming pool robot to clean the swimming pool along the cleaning path.

Further, after the water surface map of the swimming pool is created, the method includes: acquiring a water bottom map of the swimming pool, the water bottom map having a water bottom coordinate system origin; acquiring displacement between the water bottom coordinate system origin and a coordinate system origin of the water surface map; moving the water bottom coordinate system origin or the coordinate system origin of the water surface map based on the displacement, so as to align the moved water bottom coordinate system origin with the coordinate system origin of the water surface map; and in response to determining that a non-overlapped region exists at boundaries of the water bottom map and the water surface map after the alignment operation, determining the non-overlapped region as a swimming pool step region.

In a second aspect of the embodiments of the present application, there is provided a swimming pool cleaning device provided with a laser radar or a camera, swimming pool boundary information collected by a swimming pool robot being acquired through the laser radar or the camera and used to generate a water surface map of a swimming pool in combination with position information of the swimming pool robot.

Compared with the prior art, the embodiments of the present application have the following beneficial effects: in the embodiments of the present application, the instruction of creating the water surface map is generated; based on the instruction, the position information of the swimming pool robot floating on the water surface is acquired; the swimming pool boundary information collected by the swimming pool robot is acquired through the laser radar or the image sensor; and the water surface map of the swimming pool is generated based on the position information and the swimming pool boundary information, thus solving the technical problem that a current swimming pool robot does not have the swimming pool water surface map for reference during working on the water surface, realizing autonomous water surface mapping, providing convenience for water surface working of the swimming pool robot, improving a working efficiency of the swimming pool robot, and improving user experience.

### BRIEF DESCRIPTION OF THE DRAWINGS

In order to more clearly illustrate the technical solutions in the embodiments of the present application, the accompanying drawings used in the description of the embodiments or the prior art will be briefly introduced below. It is apparent that, the accompanying drawings in the following description are only some embodiments of the present application, and other drawings can be obtained by those of ordinary skill in the art from the provided drawings without creative efforts.

FIG. 1 is a schematic flowchart of a swimming-pool water surface map creating method according to an embodiment of the present application.

FIG. 2A is a schematic diagram of a global map with a non-closed boundary in the embodiment of the present application.

FIG. 2B is a schematic diagram of another global map with a non-closed boundary in the embodiment of the present application.

FIG. 3 is a schematic flowchart of a method for controlling a swimming pool robot to move to a region with a non-closed boundary in the global map in the embodiment of the present application.

FIG. 4 is a schematic flowchart of another swimming-pool water surface map creating method according to an embodiment of the present application.

FIG. 5 is a schematic flowchart of still another swimming-pool water surface map creating method according to an embodiment of the present application.

FIG. 6 is a schematic flowchart of yet another swimming-pool water surface map creating method according to an embodiment of the present application.

FIG. 7 is a schematic flowchart of another swimming-pool water surface map creating method according to an embodiment of the present application.

FIG. 8 is a schematic flowchart of another swimming-pool water surface map creating method according to an embodiment of the present application.

FIG. 9 is a schematic diagram of a swimming-pool water surface map creating apparatus according to an embodiment of the present application.

### DETAILED DESCRIPTION OF THE EMBODIMENTS

In the following description, for the purpose of illustration instead of limitation, specific details such as a particular system structure and a technology are provided to make the embodiments of the present application understood thoroughly. However, it should be understood by those skilled in the art that the present application can also be implemented in other embodiments without the specific details. In other cases, detailed description of well-known systems, apparatuses, circuits and methods is omitted, so that the present application is described without being impeded by unnecessary details.

A swimming-pool water surface map creating method and apparatus according to embodiments of the present application will be described in detail below with reference to the accompanying drawings.

As mentioned above, currently, most swimming pool robots cannot clean a water surface, and for a small number of swimming pool robots capable of cleaning the water surface, a random walking mode is generally adopted to clean the water surface, and positioning and map concepts are not involved. Such an implementation is not intelligent enough, and has a low cleaning efficiency, low coverage and poor user experience.

In view of this, the embodiment of the present application provides a swimming-pool water surface map creating method, in which an instruction of creating a water surface map is generated; based on the instruction, position information of a swimming pool robot floating on a water surface is acquired; swimming pool boundary information collected by the swimming pool robot is acquired through a laser radar or an image sensor; and the water surface map of a swimming pool is generated based on the position information and the swimming pool boundary information, thus solving the technical problem that a current swimming pool robot does not have the swimming pool water surface map for reference during working on the water surface, realizing automatic water surface mapping, providing convenience for water surface working of the swimming pool robot, improving a working efficiency of the swimming pool robot, and improving user experience.

Compared with traditional ultrasonic ranging sensor mapping, the laser radar or the image sensor used in the present application has remarkable advantages in precision, resolution, anti-interference capability, real-time performance and speed, the boundary map can be established more precisely under a single mapping condition, and when single map scanning does not cover the whole map, the global map can be obtained only by advancing to a non-closed region and then performing measurement again, such that the laser radar or the image sensor has more advantages in accuracy and operation convenience compared with an ultrasonic sensor.

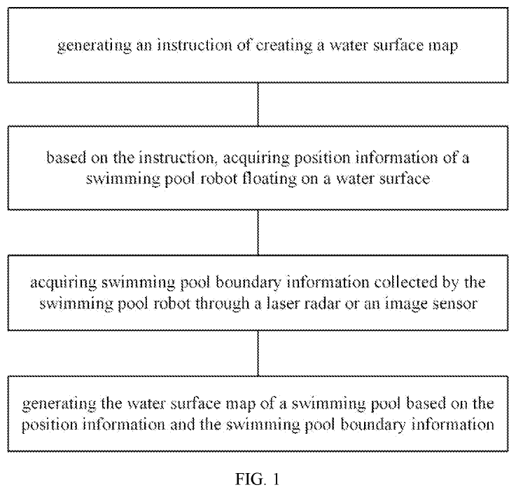

FIG. 1 is a schematic flowchart of a swimming-pool water surface map creating method according to an embodiment of the present application. As shown in FIG. 1, the method includes the following steps:
generating an instruction of creating a water surface map; based on the instruction, acquiring position information of a swimming pool robot floating on a water surface; acquiring swimming pool boundary information collected by the swimming pool robot through a laser radar or an image sensor; and generating the water surface map of a swimming pool based on the position information and the swimming pool boundary information.

The above swimming-pool water surface map creating method may be performed by a terminal. Further, the swimming-pool water surface map creating method may be performed in a swimming pool robot associated application in the terminal. The instruction of creating the water surface map can be sent by a user or triggered by the terminal when a preset condition is met.

Further, after receiving the instruction of creating the water surface map, the terminal acquires the position information of the swimming pool robot floating on the water surface; acquires the swimming pool boundary information collected by the swimming pool robot through the laser radar or the image sensor; and generates the water surface map of the swimming pool based on the position information and the swimming pool boundary information. Specifically, after the robot floats to the water surface, a loaded sensor is started to scan a surrounding environment according to the position information of the swimming pool robot, the sensor includes at least part of the swimming pool boundary information, and the swimming pool boundary information can be position information of a swimming pool wall. The sensor is a laser radar or an image sensor.

For the position information of the swimming pool robot, an initial position of the swimming pool robot may be obtained, the initial position is determined as a coordinate system origin, and a global map is generated based on the coordinate system origin and first sensor information. In the above steps, the initial position of the swimming pool robot may be a position where the swimming pool robot is located when the swimming pool robot acquires the sensor information through the sensor loaded on the swimming pool robot. The acquired initial position of the swimming pool robot may also be coordinate information of a world coordinate system, and the global map is generated based on the coordinate information and the swimming pool boundary information. Therefore, generation of the global map may include: acquiring position information relative to the pool wall detected by the sensor with the initial position of the swimming pool robot as the coordinate system origin, and converting the position information into coordinates in the coordinate system to obtain the global map. Or, the coordinate system is the world coordinate system, and the swimming pool robot may obtain the coordinate information through a positioning apparatus, such as a GPS, so as to obtain the global map.

Further, in response to the closed boundary of the global map, the global map is determined as the water surface map of the swimming pool.

In the above steps, if a boundary of the global map generated in the above manner is closed, it can be considered that the water surface map of the swimming pool is already created, and the global map is directly determined as the water surface map of the swimming pool.

That is, if the sensor loaded on the swimming pool robot has an enough measurement range and the water surface of the swimming pool has no obstacles, the global map with the closed boundary can be obtained after the swimming pool robot or the sensor loaded by the swimming pool robot performs scanning by a circle at the initial position.

Further, in response to the non-closed boundary of the global map, the swimming pool robot is controlled to move towards a region with the non-closed boundary in the global map.

In the above steps, if the boundary of the global map generated in the above manner is not closed, it can be considered that creation of the water surface map of the swimming pool is not completed, and at this point, further mapping is required. Specifically, when the measurement range of the sensor loaded by the swimming pool robot is insufficient, or the water surface of the swimming pool includes an obstacle, the swimming pool robot can only obtain a global map containing part of the swimming pool boundary information at the initial position, and at this point, the boundary of the obtained global map is not closed.

In the above steps, when it is determined that the boundary of the global map is not closed, the swimming pool robot may be controlled to move towards the region with the non-closed boundary in the global map, and boundary information of the non-closed region may be obtained to generate the final water surface map.

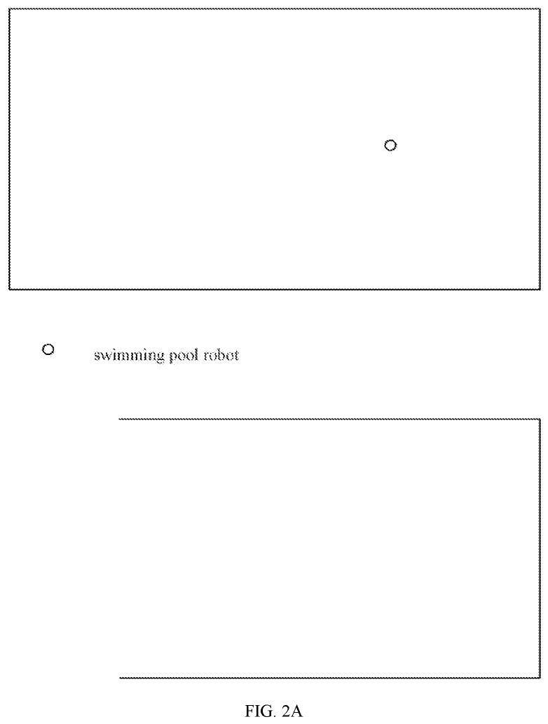

For example, as shown in FIG. 2A, the blocks in the drawing are a schematic diagram of the boundary of the swimming pool, the boundary of the swimming pool is the part of the swimming pool wall on the water surface, the swimming pool robot is located on the water surface of the swimming pool, and since the measurement range of the sensor loaded on the swimming pool robot is limited, the swimming pool robot cannot obtain information of a boundary of a left side of the swimming pool after performing scanning by a circle at the initial position, and can only obtain the global map as shown in the lower graph of FIG. 2A.

Or, as shown in FIG. 2B, the blocks in the drawing are a schematic diagram of the boundary of the swimming pool, the swimming pool robot is located on the water surface of the swimming pool, and the water surface has an obstacle. Due to obstruction of the obstacle, the global map as shown in the lower graph of FIG. 2B is obtained even if the measurement range of the sensor loaded on the swimming pool robot is sufficient.

It should be noted that the above description only gives an example of the global map with the non-closed boundary, and in actual use, the global map with the non-closed boundary further includes other situations, which are not limited herein.

In addition, when the boundary of the global map has a plurality of non-closed regions, a corresponding moving method is also provided, and specifically includes the following steps.

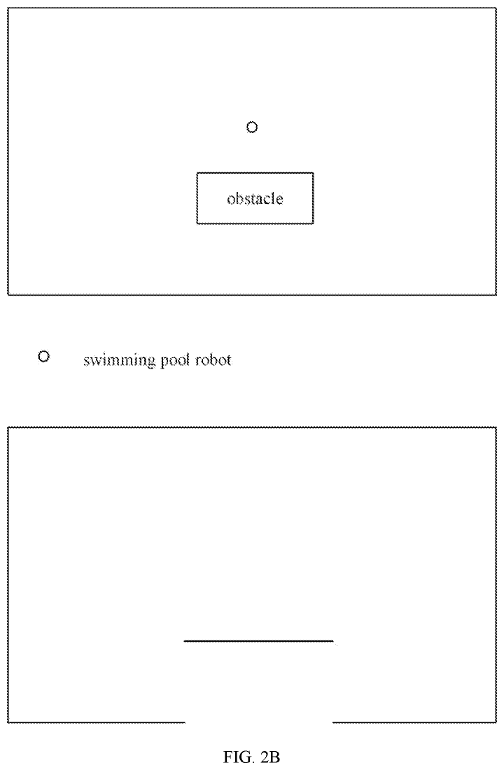

As shown in FIG. 3, the method includes the following steps:
step S301: determining a target boundary non-closed region closest to the swimming pool robot; and
step S302: controlling the swimming pool robot to move to the target boundary non-closed region.

Specifically, when at least two boundary non-closed regions are included, the target boundary non-closed region closest to the swimming pool robot currently can be determined first, and then, the swimming pool robot is controlled to move to the target boundary non-closed region to perform water surface mapping on the region until a boundary of the region is closed. Next, if a number of the remaining boundary non-closed regions is still plural, the swimming pool robot may continue to determine again a target boundary non-closed region closest to the swimming pool robot currently in the remaining plural regions, and the swimming pool robot is controlled again to move to the target boundary non-closed region until water surface mapping of all the boundary non-closed regions is completed.

Further, when the swimming pool robot is controlled to move to the boundary non-closed region in the global map, the swimming pool robot can be controlled to acquire information using the sensor loaded by the swimming pool robot while moving, and then, a local map is generated using the acquired sensor information, and the local map is superposed on the global map to obtain an updated global map. A travel path of the swimming pool robot may be calculated and planned autonomously by the terminal, such that the swimming pool robot moves to the boundary non-closed region; or the swimming pool robot may be manually controlled to move to the boundary non-closed region by a user performing an operation in the terminal, which is not limited herein.

In the embodiment of the present application, when the boundary of the updated global map is still not closed, the swimming pool robot can be continuously controlled to move to the boundary non-closed region in the global map, the sensor information is continuously acquired in the moving process, the local map is generated again according to the acquired sensor information, and the local map is superposed on the global map to obtain the updated global map again until the boundary of the updated global map is closed. At this point, the updated global map with the closed boundary may be determined as the water surface map of the swimming pool.

Further, the position information or the swimming pool boundary information is calibrated by an IMU on the swimming pool robot.

Specifically, during water surface mapping, the swimming pool robot inevitably has an inclined posture due to shaking of the water surface, the obtained position information or the obtained swimming pool boundary information has a deviation, and the map can be calibrated by acquiring posture information of the swimming pool robot at different moments through the IMU (inertial measurement unit) in combination with the position information or the swimming pool boundary information obtained by the sensor at the corresponding moments. That is, the sensor can measure a distance between the robot and the swimming pool wall or other obstacles, and in combination with posture information of the IMU, a boundary map of the swimming pool can be constructed and calibrated, and by combining the IMU and the sensor, accuracy of the position information and reliability of the boundary information can be significantly improved.

Further, the sensor loaded by the swimming pool robot can be a laser radar or an image sensor. The laser radar may be a two-dimensional laser radar or a three-dimensional laser radar.

When the sensor loaded by the swimming pool robot is a two-dimensional laser radar, the boundary information is two-dimensional laser point cloud information of a local boundary, and the local boundary at least includes part of the boundary in the boundary non-closed region.

When the sensor loaded by the swimming pool robot is a three-dimensional laser radar, the boundary information is three-dimensional laser point cloud information of the local boundary.

When the sensor loaded by the swimming pool robot is an image sensor, the boundary information is image information of the local boundary. At this point, generation of the local map based on the boundary information may include: performing feature extraction on the image information to obtain three-dimensional image feature information of the local boundary; removing vertical axis information in the three-dimensional image feature information to obtain mapping image feature information mapped to a two-dimensional plane; and drawing the mapping image feature information to a coordinate system where the global map is located, so as to obtain the local map.

That is, when the sensor loaded by the swimming pool robot is a two-dimensional laser radar or a three-dimensional laser radar, profile information of the pool wall can be obtained by the laser radar performing scanning on the water surface, and if the sensor is a single-line laser radar, i.e., a two-dimensional laser radar, a two-dimensional profile of the swimming pool is acquired, and if the sensor is a multi-line laser radar, i.e., a three-dimensional laser radar, a three-dimensional profile of the swimming pool is acquired. During movement, the swimming pool robot generates a translation quantity and a rotation quantity, the translation quantity includes an abscissa translation quantity and an ordinate translation quantity, and the rotation quantity is used for representing a moving angle of the swimming pool robot. At this point, point cloud information of a same object scanned by the laser radar loaded by the swimming pool robot correspondingly changes, and the change is a pose change after rotation and translation. A rotation value and a translation value can be calculated, such that a rotation value and a translation value of each sampling frame in the moving process of the swimming pool robot are obtained, and then, the local map is generated according to the calculated rotation value and translation value of each sampling frame.

The rotation value and the translation value of each sampling frame can be calculated in combination with the IMU. In an example, a rotation value and a translation value with errors of each sampling frame of a body of the swimming pool robot can be calculated first by the IMU performing integration, and a moving speed of the swimming pool robot is obtained. Then, a normal distribution transform (NDT) residual error between current frame point cloud data and a point cloud map is calculated with the current frame point cloud data as an observation value. Finally, the rotation value and the translation value with the errors estimated by the IMU are updated using point cloud observation data and the NDT residual error with an information-extended Kalman filter (IEKF) method, thereby obtaining a more precise rotation value and translation value of each sampling frame. Further, the local map may be generated by fixing the point cloud data of a first frame and then registering the point cloud information of the current frame into fixed point cloud of the first frame using the estimated rotation value and translation value of the point cloud of each frame to form the point cloud map.

In the embodiment of the present application, when the sensor loaded by the swimming pool robot is an image sensor, a feature point extraction algorithm can be used to extract the feature information for each image frame, and calculate a description value of a feature, and the image feature usually includes a corner feature and an edge feature. Then, feature point matching is performed on a current image frame and a previous image frame by using the description values of feature points, and relative motion between the two image frames is estimated by using a perspective-n-point (PnP) algorithm through feature point matched pairs. By adopting the mode, the current rotation value and translation value of the swimming pool robot relative to the initial position can be obtained when the swimming pool robot continuously moves, and then, the local map is generated according to the rotation value and the translation value of the robot at each position.

Further, the image sensor and the IMU can be combined to perform positioning, so as to generate the local map. In an example, a rotation value and a translation value with errors of a body of the swimming pool robot can be acquired first by the IMU performing integration, and a moving speed of the swimming pool robot is obtained. Then, line feature and point feature information of the swimming pool boundary is acquired from an image collected by the image sensor as observation. A constraint relationship between point or line features between adjacent frames is used as the observation, and the rotation value and the translation value with errors are updated by using a multi-state constraint Kalman filter (MSCKF) mode, such that an accurate pose of the swimming pool robot can be obtained. Finally, the local map is generated according to the acquired accurate pose of the swimming pool robot.

In the embodiment of the present application, when the local map is generated, if the laser radar is used or the laser radar and the IMU are fused for positioning, after the rotation value and the translation value of the laser radar are obtained, a point cloud image obtained by scanning of the laser radar can be drawn together under the world coordinate system according to a coordinate conversion relationship. When the image sensor is used or the image sensor and the IMU are fused for positioning, after the rotation value and the translation value are obtained, point and edge information of the image can be drawn under the world coordinate system according to the coordinate conversion relationship, so as to obtain a grid map.

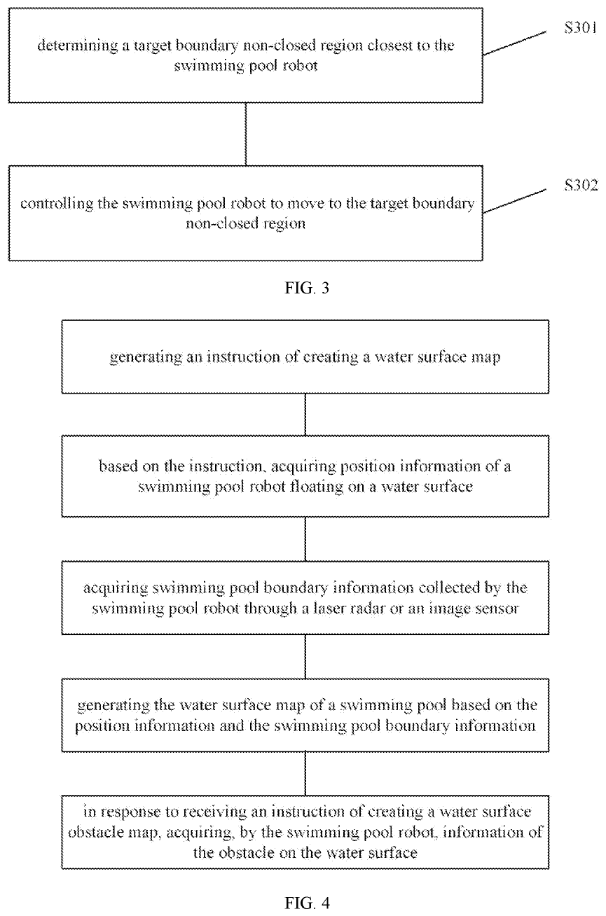

As shown in FIG. 4, the method further includes the following steps:
in response to receiving an instruction of creating a water surface obstacle map, acquiring, by the swimming pool robot, information of the obstacle on the water surface.

Further, a local obstacle map is generated based on the information of the obstacle on the water surface, and the local obstacle map is superposed on the global map to obtain the water surface obstacle map.

In the embodiment of the present application, when receiving the instruction of creating the water surface obstacle map, the terminal can acquire the information of the obstacle on the water surface from the swimming pool robot. The information of the obstacle on the water surface can be obtained by the swimming pool robot moving around the obstacle on the water surface. Further, the local obstacle map may be generated based on the information of the obstacle on the water surface, and the local obstacle map is superposed on the global map to obtain the water surface obstacle map.

That is, the swimming pool robot may encounter some large obstacles, such as toy water guns, clothes, and other daily necessities, when performing water surface cleaning. In order to improve a water surface cleaning efficiency, these obstacles may be first mapped, and then, a cleaning path of the swimming pool robot may be planned with reference to the global map and the water surface obstacle map.

When the water surface obstacle map is created, intelligent identification can be performed through point cloud of the laser radar or the image sensor (such as a camera) loaded by the swimming pool robot, a position of the obstacle under a machine coordinate system is obtained according to a corresponding algorithm, and finally, the obstacle is transferred to the map. A method for performing positioning and generating the local map during obstacle identification is substantially the same as the above-mentioned method for constructing the local map of the boundary non-closed region when the swimming pool robot moves towards the boundary non-closed region, and is not repeated herein.

It should be noted that the step of creating the local obstacle map may be performed after the creation of the water surface map of the swimming pool is completed. In some cases, the step of creating the local obstacle map may also be performed when the creation of the water surface map of the swimming pool is not completed, and at this point, after the creation of the local obstacle map is completed, the local obstacle map may be temporarily stored until the creation of the water surface map of the swimming pool is completed, and then, the local obstacle map is superimposed on the water surface map of the swimming pool to obtain the water surface obstacle map.

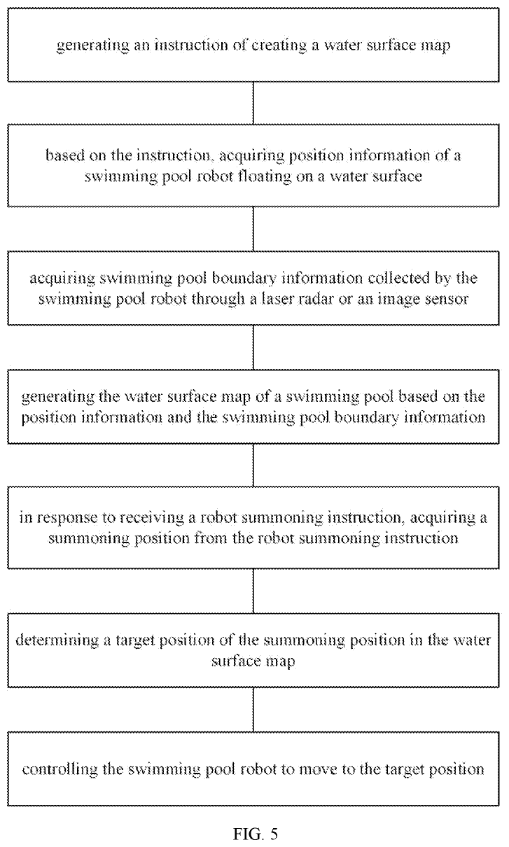

FIG. 5 is a schematic flowchart of still another swimming-pool water surface map creating method according to an embodiment of the present application. As shown in FIG. 5, the method further includes the following steps:
in response to receiving a robot summoning instruction, acquiring a summoning position from the robot summoning instruction;
determining a target position of the summoning position in the water surface map; and
controlling the swimming pool robot to move to the target position.

In the embodiment of the present application, after the water surface map of the swimming pool is created, if the terminal receives the robot summoning instruction, for example, if the user performs a robot summoning operation in an application of the terminal, the summoning position, i.e., the target position that the user expects the swimming pool robot to reach, may be obtained from the robot summoning instruction.

As the summoning instruction, the user may directly click a certain point in the water surface map as the summoning position, and at this point, the position clicked by the user is the target position of the summoning position in the water surface map. On the other hand, the summoning instruction may also be a voice instruction sent by the user, for example, “summoning the robot back to the center of the swimming pool”, and at this point, key information “the center of the swimming pool” in the voice instruction may be extracted, a center position thereof is calculated according to the water surface map of the swimming pool, and finally, the center position of the water surface map is determined as the target position of the summoning position in the water surface map.

In the embodiment of the present application, after the target position is determined, the swimming pool robot can be controlled to move to the target position, thereby realizing summoning of the swimming pool robot to any position.

That is, the swimming pool robot may be located in the middle of the swimming pool or at the water bottom after cleaning is completed, and cannot be conveniently acquired by the user. When the swimming pool robot is required to be acquired, the user can send the robot summoning instruction into the application of the terminal, the robot summoning instruction includes a position where the swimming pool robot is required, and the position is denoted by X. At this point, if the swimming pool robot is located at the water bottom, the swimming pool robot firstly vertically floats to the water surface after receiving the robot summoning instruction, and then, the collected point cloud is matched with map point cloud by rotating the laser radar, so as to determine a current position of the robot in the water surface map of the swimming pool. Next, a path to X is planned according to the determined current position, and the robot moves to X along the path, thereby completing user summoning.

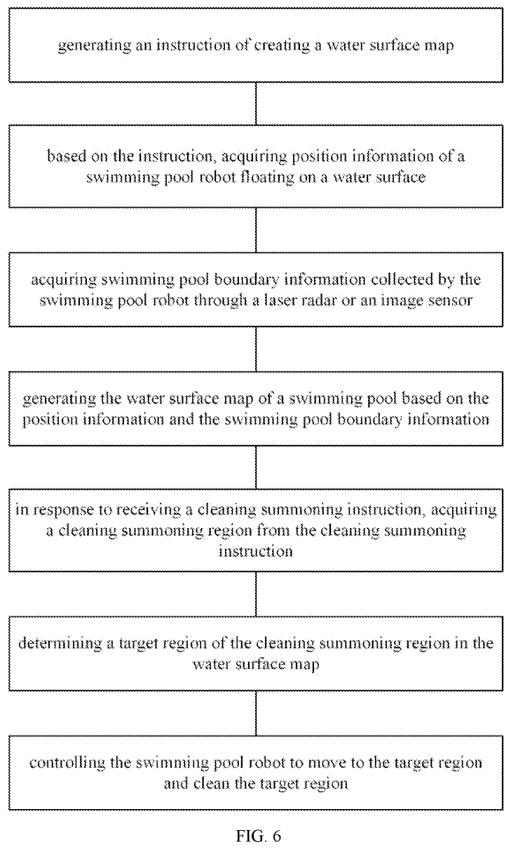

FIG. 6 is a schematic flowchart of yet another swimming-pool water surface map creating method according to an embodiment of the present application. As shown in FIG. 6, the method further includes the following steps:
in response to receiving a cleaning summoning instruction, acquiring a cleaning summoning region from the cleaning summoning instruction;
determining a target region of the cleaning summoning region in the water surface map; and
controlling the swimming pool robot to move to the target region and clean the target region.

In the embodiment of the present application, after the water surface map of the swimming pool is created, if the terminal receives the cleaning summoning instruction, the terminal can acquire the cleaning summoning region from the cleaning summoning instruction, and then determine the target region of the cleaning summoning region in the water surface map. Finally, the swimming pool robot is controlled to move to the target region and clean the target region.

That is, after the water surface map of the swimming pool is created, the user can directly specify a certain cleaning region in the water surface map of the swimming pool in the application of the terminal, and the swimming pool robot can autonomously plan a path from the current position to the specified cleaning region, so as to realize summoning cleaning. A method for determining the target region, a method for determining the current position of the swimming pool robot, and a path planning method are similar to the methods in the implementation in the embodiment shown in FIG. 5, and are not repeated herein.

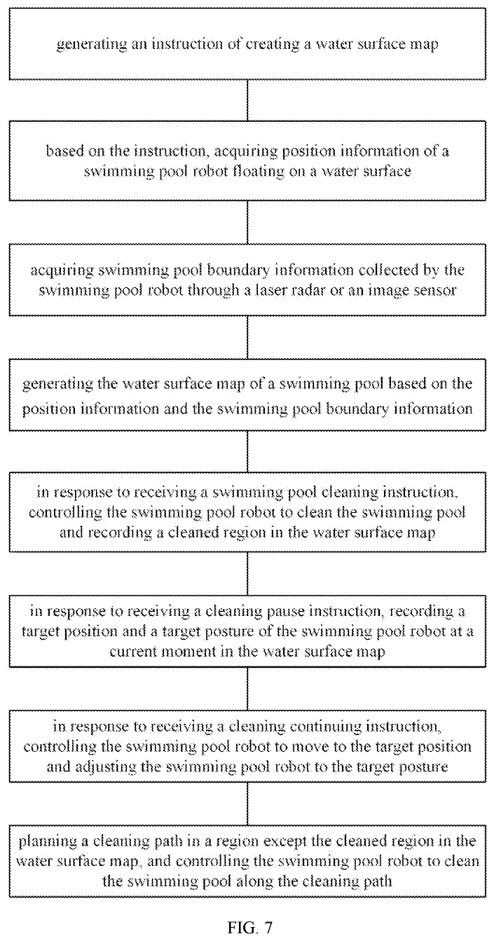

FIG. 7 is a schematic flowchart of another swimming-pool water surface map creating method according to an embodiment of the present application. As shown in FIG. 7, the method further includes the following steps:
in response to receiving a swimming pool cleaning instruction, controlling the swimming pool robot to clean the swimming pool and recording a cleaned region in the water surface map;
in response to receiving a cleaning pause instruction, recording a target position and a target posture of the swimming pool robot at a current moment in the water surface map;
in response to receiving a cleaning continuing instruction, controlling the swimming pool robot to move to the target position and adjusting the swimming pool robot to the target posture; and
planning a cleaning path in a region except the cleaned region in the water surface map, and controlling the swimming pool robot to clean the swimming pool along the cleaning path.

In the embodiment of the present application, after the water surface map of the swimming pool is created, the swimming pool robot may clean the swimming pool after receiving the swimming pool cleaning instructions and record the cleaned region in the water surface map. When the cleaning pause instruction is received, the target position and the target posture of the swimming pool robot at the current moment can be recorded in the water surface map. The cleaning pause instruction may be sent by the user through the application of the terminal, or may be automatically generated when the swimming pool robot detects that the swimming pool robot leaves water. Further, the current moment may be the moment when the swimming pool robot last cleans the swimming pool before stopping cleaning the swimming pool.

In the embodiment of the present application, when the terminal receives the cleaning continuing instruction, the swimming pool robot can be controlled to move to the target position and adjusted to the target posture. Further, the cleaning path may be planned in the region except the cleaned region in the water surface map, and the swimming pool robot is controlled to clean the swimming pool along the cleaning path.

That is, when a swimming pool cleaning task of the swimming pool robot is re-performed after an interruption, the swimming pool robot can be subjected to water surface repositioning and perform continuous sweeping based on the constructed water surface map. For example, when the user picks up the swimming pool robot and re-throws the swimming pool robot into the water, the swimming pool robot may disappear on the application of the terminal and is required to be repositioned. By controlling the robot to rotate to match the current laser point cloud with the map point cloud, the posture (including the rotation value and the translation value) of the robot can be obtained, and if the robot is successfully repositioned, the position of the robot appears on the application of the terminal, and path planning can be performed again at this point.

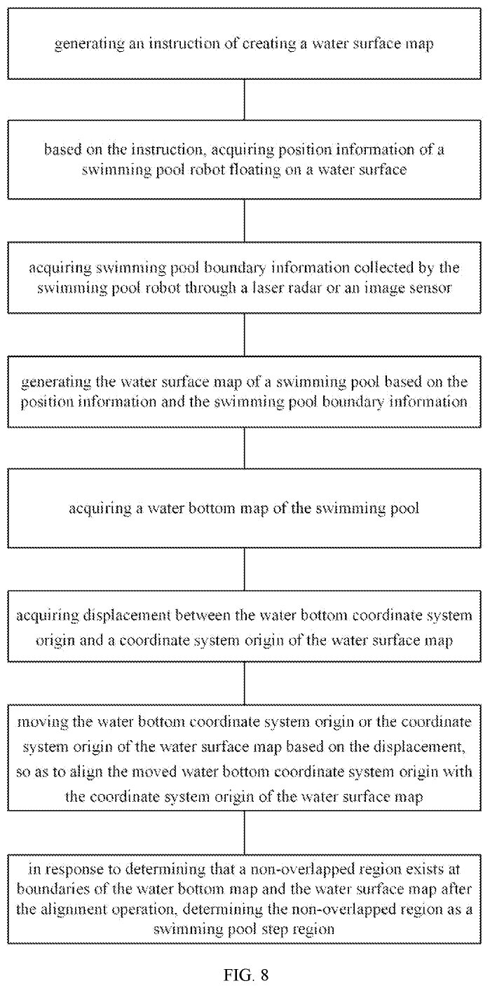

FIG. 8 is a schematic flowchart of another swimming-pool water surface map creating method according to an embodiment of the present application. As shown in FIG. 8, the method further includes the following steps:
acquiring a water bottom map of the swimming pool.

The water bottom map has a water bottom coordinate system origin.

Displacement between the water bottom coordinate system origin and a coordinate system origin of the water surface map is acquired.

In the above steps, the water bottom map may be first created and the water bottom coordinate system origin may be recorded. After the water bottom map is created, the swimming pool robot is controlled to move to the initial position for creating the water surface map, i.e., the coordinate system origin of the water surface map, so as to start to create the water surface map. In the process, the application in the terminal can record a moving track of the swimming pool robot in the whole course, and then obtain and store the displacement between the water bottom coordinate system origin and the coordinate system origin of the water surface map. It should be noted that the displacement between the water bottom coordinate system origin and the coordinate system origin of the water surface map may also be determined and stored in other manners, which is not limited herein.

The water bottom coordinate system origin or the coordinate system origin of the water surface map is moved based on the displacement, so as to align the moved water bottom coordinate system origin with the coordinate system origin of the water surface map.

In the above step, the water bottom coordinate system origin may be moved by the displacement, such that the water bottom coordinate system origin is aligned with the coordinate system origin of the water surface map. Or, the coordinate system origin of the water surface map may be moved by the displacement, such that the water bottom coordinate system origin is aligned with the coordinate system origin of the water surface map. For example, if the displacement between the water bottom coordinate system origin and the coordinate system origin of the water surface map is (−1, −1), the coordinate system origin can be moved from (0, 0) to (−1, −1) in the water surface map, such that the coordinate system origin of the water surface map is moved to the original (−1, −1) position, and at this point, the origins of the water bottom map and the water surface map are located at a same position.

In response to determining that a non-overlapped region exists at boundaries of the water bottom map and the water surface map after the alignment operation, the non-overlapped region is determined as a swimming pool step region.

In the above steps, the water bottom map and the water surface map after the alignment of the coordinate system origins can be compared, and if the non-overlapped region exists at the boundary of the swimming pool, the non-overlapped region can be determined as the swimming pool step region.

Further, the non-overlapped region may be determined as follows: if a first target point in the water bottom map and a second target point in the water surface map have a same abscissa value and ordinate values of the first target point and the second target point are larger than a preset threshold, the first target point and the second target point can be determined as non-overlapped points. If a third target point in the water bottom map and a fourth target point in the water surface map have a same ordinate value and abscissa values of the third target point and the fourth target point are greater than a preset threshold, the third target point and the fourth target point can be determined as non-overlapped points. Finally, a region formed by all the second target points and all the fourth target points in the water surface map is determined as the non-overlapped region. The preset threshold may be set according to actual needs, and is not limited herein.

That is, in the swimming-pool water surface map creating method according to the embodiment of the present application, a mapping process can be performed as follows:
1) executing a water surface mapping command;
2) locating the robot in the water surface, the robot moving autonomously;
3) defining a pose of the first frame as the world coordinate system, and defining the map generated by the sensor information of the first frame as the global map;
4) acquiring a local two-dimensional grid map through the sensor information of each timestamp;
5) estimating pose information of the robot under the world coordinate system at each moment according to the sensor information, and matching (superposing) the local grid map of the current timestamp into the global map by using the pose information; and
6) if mapping is judged to be completed, obtaining the newly created map.

The autonomous movement of the robot in step 2) may mean that: if a two-dimensional or laser radar is used, the robot may be controlled to reach the center position of the swimming pool using information of a distance from an edge of the swimming pool acquired by the laser radar. If the boundary of the map is closed at this point, mapping is completed; if the boundary of the map is not closed, the robot moves to the region with the missing map boundary until the map is completely closed. If the image acquired by the image sensor, such as the camera, is used, the robot performs spinning motion in the swimming pool. After scanning is performed by a circle, the map boundary is closed, and mapping is completed. If manual control is used, the map boundary can be closed according to a movement position of the robot operated manually, and mapping is completed.

As the mapping process in step 4), if the two-dimensional laser radar sensor is used, the two-dimensional laser point cloud information can be directly obtained, the point cloud information is drawn under the world coordinate system, and the obtained swimming pool profile is the local grid map. If the three-dimensional laser radar sensor is used, the three-dimensional point cloud is required to be mapped into the two-dimensional plane by using a z axis removal mode, and then, mapped two-dimensional point cloud information is drawn under the world coordinate system, so as to obtain the local grid map. If the image information obtained by the camera is used, the point feature and line feature information in the swimming pool environment is required to be obtained using a fast point feature extraction algorithm and a line segment detector (LSD). Three-dimensional information of image features is acquired by using a triangularization depth estimation method. Finally, the feature extraction result is mapped into the two-dimensional plane by using the z-axis removal mode, and the feature extraction result is drawn under the world coordinate system to obtain the local grid map.

By adopting the technical solution of the embodiment of the present application, the problem that the existing swimming pool robot does not have the water surface map is solved, and the constructed swimming pool water surface map can be pushed to the application of the terminal for display. On the basis of accomplishing construction of the water surface map of the swimming pool, the water surface obstacle map may be superposed and displayed, water surface summoning cleaning can be realized, water surface repositioning and continuous scanning can be realized, and this water surface map and the water bottom map of the swimming pool can be compared to realize positioning of the swimming pool step region.

All the above optional technical solutions may be combined arbitrarily to form optional embodiments of the present application, and are not repeated herein.

An apparatus according to the embodiments of the present application is described below, and may be configured to perform the method according to the embodiments of the present application. For details not disclosed in the embodiments of the apparatus according to the present application, reference is made to the embodiments of the method according to the present application.

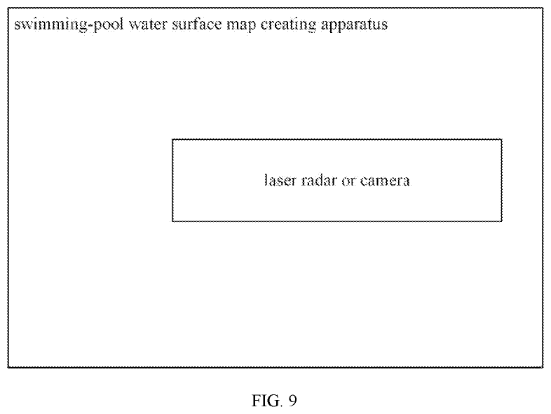

FIG. 9 is a schematic diagram of a swimming-pool water surface map creating apparatus according to an embodiment of the present application. As shown in FIG. 9, the apparatus is:
provided with a laser radar or a camera, and can execute a method, including:
generating an instruction of creating a water surface map;
based on the instruction, acquiring position information of a swimming pool robot floating on a water surface;
acquiring swimming pool boundary information collected by the swimming pool robot through a laser radar or an image sensor; and
generating the water surface map of a swimming pool based on the position information and the swimming pool boundary information.

It may be clearly understood by those skilled in the art that, for convenient and brief description, division of the above functional units and modules is used as an example for illustration. In practical application, the above functions can be allocated to different functional units and modules and implemented as required; that is, an internal structure of the apparatus is divided into different functional units or modules to accomplish all or some of the functions described above. The functional units or modules in the embodiments may be integrated into one processing unit, or each of the units may exist alone physically, or two or more units are integrated into one unit, and the integrated unit may be implemented in a form of hardware, or may also be implemented in a form of a software functional unit.

The above embodiments are merely intended to describe the technical solutions of the present application, but not to limit the present application. Although the present application is described in detail with reference to the foregoing embodiments, those of ordinary skill in the art should understand that they may still make modifications to the technical solutions described in the foregoing embodiments or make equivalent replacements to some technical features thereof. Such modifications or replacements do not cause the essence of the corresponding technical solutions to depart from the spirit and scope of the technical solutions of the embodiments of the present application, and should be included in the protection scope of the present application.

1. A swimming-pool water surface map creating method, comprising:
generating an instruction of creating a water surface map of a swimming pool;
based on the instruction, acquiring position information of a swimming pool robot floating on a water surface;
acquiring swimming pool boundary information through a laser radar or an image sensor arranged on the swimming pool robot when the swimming pool robot is at a stationary position on the water surface, wherein the swimming pool boundary information corresponds to a closed swimming pool boundary; and
generating the water surface map based on the position information and the swimming pool boundary information.

2. (canceled)

3. The swimming-pool water surface map creating method according to claim 1, wherein the position information or the swimming pool boundary information is calibrated by an inertial measurement unit on the swimming pool robot.

4. (canceled)

5. (canceled)

6. The swimming-pool water surface map creating method according to claim 1, wherein the swimming pool boundary information comprises information of obstacles on the water surface.

7. The swimming-pool water surface map creating method according to claim 1, further comprising: after the water surface map of the swimming pool is generated, in response to receiving a robot summoning instruction comprising target position information, controlling the swimming pool robot to move to a target position based on the target position information and the water surface map.

8. The swimming-pool water surface map creating method according to claim 1, further comprising: after the water surface map of the swimming pool is generated,
in response to receiving a swimming pool cleaning instruction, controlling the swimming pool robot to clean the swimming pool and recording a cleaned region in the water surface map;
in response to receiving a cleaning pause instruction, recording a target position and a target posture of the swimming pool robot at a current moment in the water surface map;
in response to receiving a cleaning continuing instruction, controlling the swimming pool robot to move to the target position and adjusting the swimming pool robot to the target posture; and
planning a cleaning path in the water surface map, and controlling the swimming pool robot to clean the swimming pool along the cleaning path.

9. The swimming-pool water surface map creating method according to claim 1, wherein after the water surface map of the swimming pool is created, the swimming-pool water surface map creating method further comprises:
acquiring a water bottom map of the swimming pool, wherein the water bottom map has a water bottom coordinate system origin;
acquiring a displacement between the water bottom coordinate system origin and a coordinate system origin of the water surface map;
moving the water bottom coordinate system origin or the coordinate system origin of the water surface map based on the displacement, to align a moved water bottom coordinate system origin with the coordinate system origin of the water surface map; and
in response to determining that a non-overlapped region exists at boundaries of the water bottom map and the water surface map after an alignment operation, determining the non-overlapped region as a swimming pool step region.

10. A swimming pool robot configured to float on a water surface and execute the swimming-pool water surface map creating method according to claim 1, comprising:
a laser radar or a camera.

11. The swimming-pool water surface map creating method according to claim 1, wherein the position information or the swimming pool boundary information is calibrated by an inertial measurement unit on the swimming pool robot.

12. The swimming-pool water surface map creating method according to claim 1, further comprising: after the water surface map of the swimming pool is generated, in response to receiving a robot summoning instruction comprising target position information, controlling the swimming pool robot to move to a target position based on the target position information and the water surface map.

13. The swimming-pool water surface map creating method according to claim 1, further comprising: after the water surface map of the swimming pool is generated,
in response to receiving a swimming pool cleaning instruction, controlling the swimming pool robot to clean the swimming pool and recording a cleaned region in the water surface map;
in response to receiving a cleaning pause instruction, recording a target position and a target posture of the swimming pool robot at a current moment in the water surface map;
in response to receiving a cleaning continuing instruction, controlling the swimming pool robot to move to the target position and adjusting the swimming pool robot to the target posture; and
planning a cleaning path in the water surface map, and controlling the swimming pool robot to clean the swimming pool along the cleaning path.

14. The swimming-pool water surface map creating method according to claim 1, wherein after the water surface map of the swimming pool is created, the swimming-pool water surface map creating method further comprises:
acquiring a water bottom map of the swimming pool, wherein the water bottom map has a water bottom coordinate system origin;
acquiring a displacement between the water bottom coordinate system origin and a coordinate system origin of the water surface map;
moving the water bottom coordinate system origin or the coordinate system origin of the water surface map based on the displacement, to align a moved water bottom coordinate system origin with the coordinate system origin of the water surface map; and
in response to determining that a non-overlapped region exists at boundaries of the water bottom map and the water surface map after an alignment operation, determining the non-overlapped region as a swimming pool step region.

15. (canceled)

16. The swimming pool robot according to claim 10, wherein in the swimming-pool water surface map creating method, the position information or the swimming pool boundary information is calibrated by an inertial measurement unit on the swimming pool robot.

17. (canceled)

18. (canceled)

19. The swimming pool robot according to claim 10, wherein in the swimming-pool water surface map creating method, the swimming pool boundary information comprises information of obstacles on the water surface.

20. The swimming pool robot according to claim 10, wherein the swimming-pool water surface map creating method further comprises: after the water surface map of the swimming pool is generated, in response to receiving a robot summoning instruction comprising target position information, controlling the swimming pool robot to move to a target position based on the target position information and the water surface map.
